(19) United States
(12) Patent Application Publication
(10) Pub. No.: US 2019/0259292 A1
(43) Pub. Date: Aug. 22, 2019

(54) SYSTEM AND METHOD OF MODELING A REAL WORLD ENVIRONMENT AND ANALYZING A USER'S ACTIONS WITHIN THE MODELED ENVIRONMENT

(71) Applicant: CompuCog, Inc., Lynn, MA (US)

(72) Inventor: Harris E. Williams, Lynn, MA (US)

(73) Assignee: CompuCog, Inc., Lynn, MA (US)

(21) Appl. No.: 16/283,326

(22) Filed: Feb. 22, 2019

Related U.S. Application Data
(60) Provisional application No. 62/633,875, filed on Feb. 22, 2018.

(51) Int. Cl. G09B 7/04; G06T 19/00; G09B 9/00; G06K 9/62

(52) U.S. Cl. CPC G09B 7/04; G06K 9/6282; G09B 9/00; G06T 19/003

(57) ABSTRACT

A system and method that models stationary and live motion scenarios of a real world environment. A database is populated with various scenarios which include entities with decision trees which are traversed over a number of time steps. A scenario is selected. A first model of the selected scenario is generated in which the user controls a selected entity. Additional models are then generated to determine the expected or desired actions of other entities within the scenario based on the actions of the user controlled entity. Feedback, such as a grade, is given to the user based on their extent to which the actions of their controlled entity deviated from the desired actions of the modeled entity.

### CROSS REFERENCE TO RELATED APPLICATIONS

This application claims priority to and the benefit of U.S. Provisional Patent Application No. 62/633,875, filed on Feb. 22, 2018 and titled “Apparatus and Method for Observation and Evaluation of Player Performance in an Athletic Activity”, the contents of which are incorporated herein by reference as though fully set forth herein.

### FIELD OF THE TECHNOLOGY

The subject disclosure relates to modeling an environment, and more particularly to analyzing user actions within a modeled real world environment.

### BACKGROUND

Currently most nonlinear scenario decision models are created by humans with the aid of computers. Though the scenarios that are being modeled have many similarities, the variable differences in the scenarios are what affect the model's depicted characteristics. To account for the unique characteristic changes, the human user must spend a great deal of time recreating every scenario they desire to illustrate.

In the area of stationary models, there have been some advancements with computer-aided drawing tools that expedite this process. Many choose to use computer drawing tools instead of hand drawing. But in either case, both tools create highly static models that must be redrawn for every change in the scenario. These types of stationary depictions are limited when modeling scenarios that take place in live-motion in the real world because the depictions fail to show what happens in the scenario after time 0.

In the area of live-motion models, there have been advancements in computer programs that aid in live-motion simulations but these programs tend to be highly dependent on real world data, such as film, real world statistics, testimonials, and other observations. In some cases, a large amount of parameters about the scenario are required before the model can be created. An example of this is in the creation of a 3-Dimensional virtual scenario, where all aspects of the scenario must be artistically designed and accounted for in the creation of the scenario. Often the real world information is not available, which may be very detrimental and stop a user from creating a model or forecasting a situation that has not occurred in real-life. This can result in the data input process for a single scenario being so expensive that there is only enough time to create a few scenarios. Which may stifle a user's ability to gain a full understanding of all possibilities. Finally, these types of models suffer from the same static nature as the stationary models discussed above. Consequently, these types of models must too be recreated to account for the characteristic changes of different scenarios.

An accurate model of a scenario can be utilized as a tool to test and grade a user's understanding of the scenario using different testing methods. Standard tests tend to be structured with a question(s) and the corresponding response. Standard tests may be on paper, flash cards, a computer or a smartphone. The questions may contain one or a combination of text, image, audio, and video. The user is required to textually or vocally describe, fill-in the blank, select from multiple a choice set or draw the actions they would perform if they were an actor or entity in a given scenario (notably, the terms actor and entity are used interchangeably herein to refer to a person or object which is variable within a scenario). The questions in this form of testing rely on static representations of scenario-models and are subject to the same time consuming activities discussed above. Furthermore each test must be graded, which is another time consuming process. Grading done by a human can lead to fatigue and possible user error. Moreover, the testee may forget the questions and or the related information pertaining to the test in the time between completing the test and receiving the grade, consequently nullifying any future avenues for improvement as the information tested cannot be built upon as it is forgotten. Finally the presentation of the information is highly dependent on the user's language skills when the questions or responses are text or audio based. When stationary images are used to describe a live-motion scenario, the testee is required to draw a response which is limited by the testee's imagination and drawing skills. Because the user may have to overcome the hurdles related to their language-skill and creative skills, it may negatively affect test performance, which has no relation to the user's actual understanding of the scenario.

Another type of testing is state-based testing. This type of testing is structured such that the questions or user prompts are interspersed between or meshed with states of a given scenario. Examples of this type of apparatuses are described in U.S. Pat. No. 7,163,513 to Darby et al. and United States Patent Application Publication No. 2008-0220399 A1 to Giwa. The states are time stepped stationary images, text of the scenario, or video clips of the scenario. The process proceeds as follows: the state is displayed and then during or after the state is complete the user is prompted to perform an action that they will be graded on. The user input actions may be interpreted through buttons, vocal commands, and/or hand gestures. The input is noted and the test continues to the next state of the scenario, this process is repeated until the test is concluded. Though this form of testing overcomes the limitation imposed by only showing the user time 0 depictions and the creative-skills challenge discussed above, it is still time consuming to create and grade. In the event that each state is a stationary image or text, the creator of the test must create many more scenario depictions compared to standard tests, which augments the time it takes to create this form of test. Due to the finite segmented nature of the prompts, where the system is expecting an answer at a predetermined window of time, the system can be gamed. For example, the user can anticipate the next prompt window prior to the prompt. Furthermore, if the response window occurs at a time when the user is still in the decision process they may miss the chance to respond. Lastly, because there are succinct windows for the response, it reduces the realism of scenarios that are flow-based where response windows may overlap each other. The use of video in this testing procedure requires either real-world data or 3D simulations whose drawbacks have been discussed above.

In some cases, real-life scenario recreation can be used to test, grade, and ultimately improve a user's ability to act within a real world scenario. Real-life scenario recreation is the process of simulating the scenario in the real-world. Examples of this include sport practices, play rehearsals, live military combat training exercises, and medical cadaver training exercises. Though these training exercises are incredibly informative, they are the most expensive and time consuming to create. Furthermore because of the unstructured nature of the user's actions in these tests, they require direct observation by a supervisor for grading. It should be noted that with the proliferation of virtual reality technology, the expense and time consumption of creating these tests has been greatly reduced. The virtual practice form in sports is well described in the United States Patent Application Publication No. 2017-0039881 A1 to Belch et al. (hereinafter “Belch”). A drawback of current virtual practicing is that it still requires a human supervisor for grading. Without a supervisor, the simulated training apparatus lacks the ability for grading and it can be difficult for the user to know if the actions they are taken are correct or incorrect. Thus a human supervisor is often used to grade the simulated practices. With the addition of a human supervisor, the tests become susceptible to biases and fatigue that may negatively affect the user's perceived performance. Other drawbacks arise in grading using real-life scenario recreation depending on the particular method of grading used. In the example provided by Belch, for example, the practice simulations are entirely dependent on video or the real-world, the drawbacks to which were discussed above.

### SUMMARY

In light of the needs described above, in at least one aspect, there is a need to grade a user's actions within a real world environment in a manner that is cheap, efficient, and accurately grades an individual while avoiding human error such as testing bias and fatigue.

In general, the system and corresponding methods of the subject technology operate a modeling and testing apparatus that carries out live-motion task based models within a real world environment. The system combines minimal human inputted actions (i.e. their decisions) that are associated with non-linear programmatic rules and assignments that mimic real world tasks to generate simulated stationary and live-motion models of a given scenario. The system saves the user time, as it is able to use nominal knowledge taught to it by a human to model scenarios it has not been taught. The simulation models contain entities (e.g. actors and objects) that move in real-time. A human is able to test their decision-making ability in a simulated environment and the system is able to give them instantaneous test results and feedback to improve their decision-making ability. The user does this by taking control of a simulated actor's actions in a simulated scenario. While the scenario is being played out in real time the system assesses the user's actions and action-locations closeness and timing and compares it to the system's modeled actions and action-locations. The degree of closeness to the modeled actions is considered the human's degree of correctness. Thus the system is able to instantaneously grade the user's tests. This correctness is formulated into a numeric grade and textual or audio feedback is provided to the user immediately after the test. This grading information is aggregated and filtered to be used in future test selection. It is also used to predict a user's mental aptitude for a new scenario or set of scenarios. Furthermore, this information is combined with real-world data as a prediction to a user's actions and performance in similar real-world scenarios. This system is useful in training and assessing suitability of personnel in the military, airline pilots, machinery operators, sportspersons, play and movie actors, drivers, and in many other applications, particular those involving a person who is required to complete an arbitrary finite amount of tasks.

### BRIEF DESCRIPTION OF THE DRAWINGS

So that those having ordinary skill in the art to which the disclosed system pertains will more readily understand how to make and use the same, reference may be had to the following drawings.

FIG. 1 is a simple logic flowchart depicting actions of a method, or a system carrying out a method, in accordance with the subject technology.

FIG. 2 is an exemplary decision tree for a scenario in accordance with the subject technology.

FIG. 3 is a traversal of an exemplary decision tree in accordance with the subject technology.

FIG. 4 is a Polymorphic Feedback Map (PFM) for comparing scenarios in accordance with the subject technology.

FIG. 5 is a diagram illustrating a combination of multiple PFMs for a single scenario.

FIG. 6 is a diagram of exemplary assignment vectors entered by users and created by a system in accordance with the subject technology.

FIG. 7a is an exemplary model of a scenario in accordance with the subject technology.

FIG. 7b is a zoomed in portion of the model of FIG. 7a which includes greater detail in accordance with the subject technology.

FIG. 8a is another exemplary model of a scenario in accordance with the subject technology.

FIG. 8b is an exemplary decision tree for an entity shown in the model of FIG. 8a in accordance with the subject technology.

### DETAILED DESCRIPTION

The subject technology overcomes many of the prior art problems associated with analyzing user actions within a real world environment. The advantages, and other features of the systems and methods disclosed herein, will become more readily apparent to those having ordinary skill in the art from the following detailed description of certain preferred embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e. where an “upper” part must always be on top).

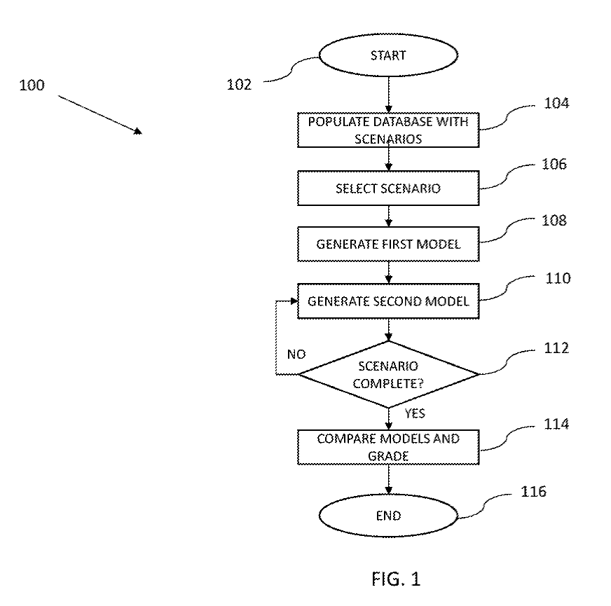

Referring now to FIG. 1, a simple logic flowchart depicting actions of a method, or system carrying out a method, in accordance with the subject technology is shown generally at 100. For simplicity, certain details are omitted from the flowchart 100 and are discussed more below. In general, the system/method represented by flowchart 100 allows a user to take action within a modeled scenario and receive feedback on their actions. Usage can be broken into three activities: viewing models, user-controlled testing, and data input, which are described in more detail below.

At step 102, the method begins. At step 104, a database is populated with a plurality of scenarios. The scenarios include the information relied upon to model a particular real world environment, and the scenarios in any particular case will be dependent on what application the user intends to use the system for. To that end, the scenarios include information describing static objects within the environment, variable objects within the environment, and rules which govern how variable objects can move within the environment. Each scenario also includes one or more entities, which can be people or other variable objects which take some action within the modeled environment of the scenario. For example, in a scenario modeling a football play, each football player may be an entity located somewhere on a football field while the football field itself is a static object within the scenario. In other cases, a vehicle, such as a car, may be an entity within a scenario related to a vehicle drive path. Each scenario is carried out over a period of time. Intervals of time over the course of a scenario are described herein as time steps. Each entity in a scenario has a decision tree which includes possible actions associated with each time step which are carried out (i.e. modeled) over the course of the scenario, unless affected by some change within the scenario. The system activity traverses an entity's decision-tree to provide a particular action for a moment in time. Every momentary action from the tree traversal is used as a basis for the movement or actions of the actors in the given scenario. At first, step 104 can be accomplished by a user populating the database with scenarios by manually entering information related to the scenarios. However, as described in more detail below, when the system begins accumulating multiple similar scenarios, the system has the ability to fill in information for new scenarios based on the information from other scenarios. Once the system database is populated with a sufficient number of scenarios at step 104, the system can be used to model and grade a user.

There are primarily two types of potential users of the system. The first person is typically in the role of an instructor teaching a second person, who is in the role of testee. The terms “instructor” and “testee” are used herein to describe general roles, it being understood that the modeling environment creates an instructor/testee dynamic which might be considered atypical. For example, an “instructor” might be a football coach or drill sergeant while the “testee” might be a football player or soldier in training, respectively. At step 106, the user selects a particular scenario for the system to model.

At step 108, a first model of the selected scenario is carried out. The model reflects the actions of entities within the scenario over a period of time. The entities within the scenario follow their decision tree, carrying out one or more of the possible actions indicated by their decision tree for a given time step of the scenario. These possible actions can include the movement and/or position of the entity within the environment or event-type actions (“events”), which are related to something the entity is doing unrelated to their position or movement. For example, if the entity is a drone, the actions can include the drone's movements in the environment, as well as events of the drone, such as taking a picture or transmitting data. The model generated is a culmination of all the entity's actions over a time for the scenario. However, at step 108, the user also controls the actions of one of the entities within the first model. In this way, the user controls the entity in the live-motion real world model. Thus, as the selected scenario is modeled, the user dictates what actions the controlled entity will take. That can include a position and/or movements for that entity within the real world environment, or events.

Within the scenario, the user may control the selected entity by interacting with an input device(s) that mimic the actual device used when in the real world. As an example, this can include aeronautics or space cockpit reconstructions and automobile reconstructions to depict a corresponding real world environment. In the event that the real-world environment cannot be recreated, virtual environments may be created. In that case, the user will interact with the system via mouse, keyboard, touchscreen, microphone, computer vision gesture controls, eye gaze, gamepad and or joystick. The input and output sources are connected to a computer that computes graphical and other modeling and testing information. This local computer may be connected to other remote computer(s) that compute and transmit ancillary information regarding the models, tests, user(s) and graphics. As the scenario is modeled at step 108, a model is created which reflects the scenario as modified by the user's actions in controlling the controlled entity.

At step 110, a second model is generated based on the new actions of the user controlled entity from step 108. The second model is carried out for a time step where the user has controlled the selected entity to change an expected action of the selected entity. The second model provides a new simulation of the scenario at that time step to determine one or more desired actions for the user during that time step, given the new position of the user controlled entity at the start of that time step. In other words, the user's actions have changed the scenario from the expected decision trees of each entity, so one or more new models must now be provided to determine the actions of the entities. For example, one scenario might include a car as the user controlled entity which has a decision tree indicating the car is supposed to drive straight during a first and second time step, then turn right during a third time step, and then stop during a fourth time step. However, if the user were to stop the car during the second time step, then the desired action at the third time step may be “drive forward” rather than “turn right”, since the vehicle must still cover additional ground before it reaches the location of the turn. As a result, a second model must then be generated for the third time step to simulate the new scenario and determine a new desired action (e.g. “drive forward”) for the user controlled entity in light of the actions previously taken by the user.

At step 112, the system examines whether the scenario has been completed. If the scenario has not yet been completed, step 112 returns to step 110 to generate a second model for the remaining time steps. This allows a new desired action to be determined for each time step. Building on the example above, suppose after stopping during the third time step, the user did in fact drive forward during the third time step, returning them to the location where they were expected to turn in the scenario. The system would now generate a second model for the fourth time step where the desired action would indicate they were supposed to turn. Even though the user was initially supposed to “stop” during the fourth time step, the new second model for this time step recognizes that the turn still needs to be made, and therefore there is a new desired action at this time step. The benefit of creating second models for each time step is that the user can be graded on their performance at each time step by comparing the suggested action of the user to the desired action at that time step. For example, in the example provided above, suppose the user recognized their error in stopping, and then proceeded to go forward and turn appropriately after their incorrect stop. In this case, the user would have made one incorrect action in stopping initially but then made the correct choices, even though they were now out of position at every future time step of the scenario. Rather than giving the user a poor grade at every successive time step of the scenario, the comparison of the suggested actions to the new desired actions in the second models allows the system to recognize that the user has taken appropriate actions at certain steps after an initial error given the changed nature of the scenario. Therefore at step 112, the system assesses whether the scenario is complete, or whether additional second models need to be generated at step 110.

Through this process both the instructor and the testee may view the models at any time. Notably, the terms first and second models are only used herein to help distinguish what is being shown and/or changed within the scenario in each case. It should be understood that either model could be presented to the user at any time, and/or both models could be presented to the user as a unified model. As an example, the numerous second models could be combined into a single model showing the scenario as a whole. In all cases, the user is viewing modeled diagrams via an output source: a computer monitor, projector, television screen, smartphone screen or virtual reality headset. Audio may be coupled with the modeled diagrams and heard through speakers or an accompanying headset during use of the system and/or method of the subject technology.

The instructor can view the models to forecast real world performance of their modeled strategy as well as develop and understanding of real world performance of their testee. The testee can view the models to gain and understanding of how to effectively perform in a given scenario. Testee's use the tests as an alternative form or practice to their traditional means. And instructors use the tests to augment the user's experience in a given scenario.

Throughout the simulation, the user is actively attempting to make the actions of the user controlled entity mirror the correct decision tree for the user controlled entity as closely as possible (the correct decision tree being represented by the desired actions indicated by the second models). At step 114, formal feedback is provided to the user based on their performance (i.e. the performance of the user controlled entity) and the accuracy with which that entity's user controlled actions traversed the decision tree for that entity. In one example, this includes a comparison of the user suggested action to the desired action determined by the second models at each time step of the scenario. The user is thought to have successfully performed an action when the user's suggested actions land within a predetermined proximity of the desired action at each time step. In some cases, the user suggested actions are considered assignments (notably, the term “assignment” is used herein to discuss an action tied to a particular scenario) and are reflected in vector form as assignment-vectors of the first model. The user suggested actions can be represented by suggested assignment vectors which model the path of suggested actions from the user. This is done be creating a vector by plotting a point, an angle of intention, and a bound to generate a vector which reflects a movement path of an entity. During generation of the second models, corresponding desired assignment vectors can model a path for the selected entity during each time step based on the desired actions for that entity. Then, the final grade assigned to the user can be based on a comparison of the suggested and desired assignment vectors at each time step. Corresponding assignment-vectors can thus be generated by the assignment (e.g. action) in that entity's decision tree or as determined through the models. The system can mark successfully performed scenarios (or actions within a scenario) while noting actions that were missed. The user can receive the feedback in many forms, including a grade for each time step, an overall grade for the scenario, and/or targeted feedback including written words describing what they should have done and/or what they should do differently in the future. After the user has received feedback, the flowchart ends at step 116. The system and/or method can then be repeated as desired in whole or in part (e.g. steps 106 onward) when a user desires to model a different scenario.

If desired, the system can be cumulative in nature, tracking past performance of one or more users over the course of one or more scenarios and recording cumulative data. This grading information is saved and fed back into the system so that the system can gain an understanding of the user's mental aptitude. The system uses these metrics and collaborative filtering techniques with other users on the system to predict future performance for new scenarios the user has not performed. The system will then use this information to test the user in scenarios it predicts the user will struggle with, in an attempt to have the user improve on their mentally weakest areas.

Particular details of the scenarios and modeling will now be described in more detail. As noted above, each scenario is governed in part by rules. The rules within each scenario govern how objects move within the environment of the scenario are programmatic rules that mimic real life. The actual architecture o a rule may come in several different forms, including but are not limited to artificial-neural-networks, mathematical equations, and logical expressions. These rules are primarily coded by the developer of the system. The system recognizes that the developer may be susceptible to human error and maintains the ability to gradually change these rules over time based on an aggregated analysis of many user's inputs from the system's testing feature. Rules are classified into two different categories, general-laws (laws) and scenario-assignments (assignments). The term “assignment” is used herein to describe particular actions which are tied to a specific scenario. Assignments rely on the general laws, general laws are immutable by the user. Certain situations rely on different sets of rules compared to other situations. For example, autonomous military aerial drone simulation relies on the basic laws of physics (law), the laws of weather (law), aerodynamics (law), mission objectives (assignment) and rules of engagement (assignment). Whereas a football playbook simulation relies primarily on the basic laws of physics (law), standard football rules (law), the team's overall strategy (assignment), player psychology (law), and football assignment and alignment rules (assignment). Neither simulation is limited to the aforementioned rules, the rules mentioned are used as an example to illustrate the differences between the two. Laws are generally common principles, well established mathematical principles, widely accepted theory or industry standard guidelines or rules. They typically are scenario independent and change infrequently. In one example, the first time a user opens the system they are prompted to set the general laws of the system. These laws will be defaulted to when scenarios are created in the future if no other laws are specified. From here they are first prompted to specify the general laws of the scenario. Assignments are rules that are dependent on the situation and change frequently from one scenario to the next. They are highly adaptable and allow user customizability.

When activated, an assignment produces an assignment vector or another assignment it is connected to. When an assignment returns an assignment-vector or another assignment it is connected to, the output is predicated on the underlying logic of the assignment. An entity's action in a simulation is the interpolated movement or activity towards the assignment vector. Each entity in the simulated scenario has a set of assignments (i.e. possible actions). Each set of assignments is not necessarily the same as the other entity's assignment sets in the scenario and the connections between each assignment can differ as well. This vast interconnection of assignments for a given entity will constitute a decision tree. Outside stimuli from the entity's environment will direct the decision making within the tree. The stimuli includes but is not limited to the current and other entity(s) location(s), location of general objects with the scenario, other entity's assignments, other entity's decisions, other entity's actions, current time, current and other entity's roles, general laws, current time, other entity's linear and angular speed and the entity's alternate dimensional assignments. Once the entity triggers an assignment node within a decision tree, a vector location corresponding to the location of the assignment is produced. The action movement or activity towards the assignment vector is interpolated based on the physical characteristics of the particular entity. The physical characteristics are a set of parameters that govern the physical limits of the entity, these are most often a combination of laws assigned to each entity by the user. The physical characteristics include but are not limited to the imposed friction coefficient, dimensions, weight, mass, maximum and minimum linear speed, linear acceleration, angular velocity, assignment decision making speed, assignment decision making accuracy. Physical characteristics are given to each entity depending on their role in the scenario.

Information about each specific scenario can be contained in the scenario-metadata (or “metadata”). This is higher level information used to set the scenarios characteristics. This information includes but is not limited to: scenario laws, actor physical characteristics, opposing actors, amount of actors, the Polymorphic Feedback Maps (“PFMs”) used, scenario geographical location, time, a set of scenario end events, and non-autonomous scenario objects. Non-autonomous scenario objects may be but are not limited to: balls, walls, ground surface, weather, terrain, atmosphere, structures, vehicles, weapons, equipment, land formation, and furniture. The metadata is hashed in the key-value map pairing in a PFM, which will be explained in more detail in the Polymorphic Feedback Map section. A scenario end action is a hard-coded event or other type of action that may occur in the scenario. When a scenario end event occurs the system is informed to terminate a scenario that is being modeled in live-motion.

Notably, a dimensional component is applied to the assignments, decision-trees and PFMs so that an actor may be acting on more than one assignment at a time. Dimensions are categorized by the function or feature they affect in the given actor, such that no two dimensions may cause the same action nor affect the same characteristics in the actor. An example of this is in American football, when an actor is assigned a location to line up prior to the start of a play, that information can be the first dimensional assignment. Additionally information what they are supposed to do after the play has started is a second dimensional assignment. In an example for an autonomous drone, the dimensions may be separated based on the features of the drone. First dimensional assignments may be associated to the camera and second dimensional assignments may be associated to the flight controls. Dimensionality of decision-trees enables the calculations of assignment-actions to occur concurrently. It also increases the modularization of the components of the simulation which enables users to build the model faster as they may reuse parts that have been inputted already.

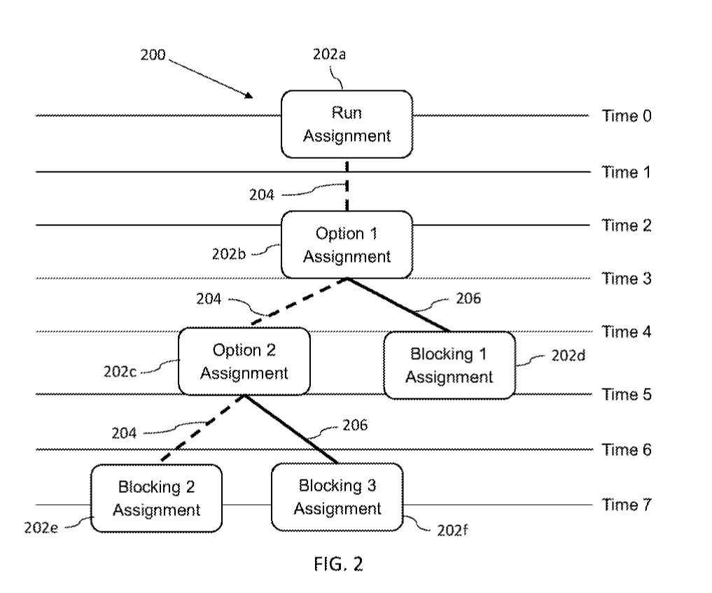

Referring now to FIG. 2, an exemplary decision tree for a scenario in accordance with the subject technology is shown at 200. The user may teach the system what should happen in a scenario by creating decision-trees for a given scenario for a set of entities. This can happen, for example, at step 104 of FIG. 1. As the user inputs the assignments 202a-202f (generally 202) of the given into the system, the assignments 202 are organized into a decision-tree such as the tree 200. As with the assignments described above, the assignments 202 represent actions for different time steps specific to a given scenario. Each entity maintains its own decision tree for a given scenario and these decision trees play out as the scenarios are modeled (e.g. steps 108 and 110 of FIG. 1). Links connect assignments 202 and each assignment 202 is considered a node within the decision tree. While a scenario is modeled, outside stimuli are fed into the assignments within the decision tree 200. As a decision path is traversed, each assignment 202 will return one of three variables: an assignment-vector (use to interpolate the entity's actions); a lower order assignment; or a higher order parental assignment. A parental higher order assignment is an assignment 202 connected to it that is at a higher level in the tree 200. A lower order assignment is an assignment 202 that is connected but at a lower level within the tree 200. If another assignment 202 is returned, the system will act recursively by examining the returned assignment 202 with the given stimuli. It will continue to do that until an assignment-vector is returned. The vector is used as a guide for the entity's actions, depending on the assignment type. For example, in an autonomous military aerial drone simulation scenario, the assignment may be to take a picture and the vector may be a longitude (X) and latitude (Y) with a Z parameter marking elevation, in which case the entity's corresponding action would be to take a picture of the target at the vector X, Y, Z. In a football example the assignment could be to throw a ball with a return vector at X, Y, and accordingly, the entity will throw the ball to the location X, Y.

In the example shown in FIG. 2, a stationary model of the decision tree 200 is provided for an exemplary football play scenario. The time steps, labeled “Time 0” through “Time 7” are depicted next to the assignments 202 which are scheduled to take place during that time step. The line 204 depicts the terminal path chosen by the system, which is the most probable path the system calculates based on the stimuli known at Time 0. The Time-0 terminal path's output is diagrammed on the screen, as shown by line 204 of FIG. 2, with an indication that this is the highest probable action that the particular actor will undertake in the given scenario. Next, the system will work recursively and step through the lower order nodes that are connected to the terminal assignments 202 of the Time-0 terminal path 204 (If there are no lower order nodes the system will not perform this step). As the system steps to lower order assignments 202 within the tree 200, the system will pass in the Time-0 stimuli to the given assignment 202. As the scenario is modeled, the time steps base by and the decision tree 200 is traversed from top to bottom (as shown in the figure).

Therefore at the time steps labeled Time 0 and 1, an entity executing the decision tree would be performing the first assignment 202a, which is a run assignment. Then, between Time 1 and 2, the scenario stimuli changed to the extent that the run assignment 202a returned its child assignment, assignment 202b, which is an option assignment. Assignment 202b is an option assignment because it is connected to multiple other assignments 202. In this case, the option assignment 202b may return one of two possible lower order assignments, assignment 202c or assignment 202d. Depending on external stimuli the selection of the assignment 202c, 202d will be made as the scenario is modeled. At the time step labeled Time 4, the system switches to the lower order option, assignment 202c, via path 204. Path 206 represents the path not taken, which at this time step represents the option to go to assignment 202d which is a blocking assignment. The traversal then continues through path 204 from assignment 202c, which is another option assignment, this time with options between two block assignments 202e, 202f. The external stimuli direct the entity down the traversal path 204 which elects blocking assignment 202e at the final time step, Time 7. The diagrams presented to the user in a scenario diagram of a decision tree such as FIG. 2 include, but are not limited to, lines depicting paths or actions, probability clouds or boxes depicting a probabilistic area that an actor or object's location may be in the future and lines connecting the actor to other actors or scenario-objects to denote the connection of actions between the actors. The way the probability of the different assignments 202 are depicted includes, but is not limited to, opacity, a textual display of the probability percentage, changing the color of the diagram, and dotted lines. Action diagrams can be hard-coded into the system by a programmer, with each action having a diagram depicting an action in a 2-D or 3-D point of view. The example described in FIG. 2 is an example of a linear traversal through a decision tree 200. Because of the stochastic nature of the scenario variables, the external scenario may cause non-linear tree traversal.

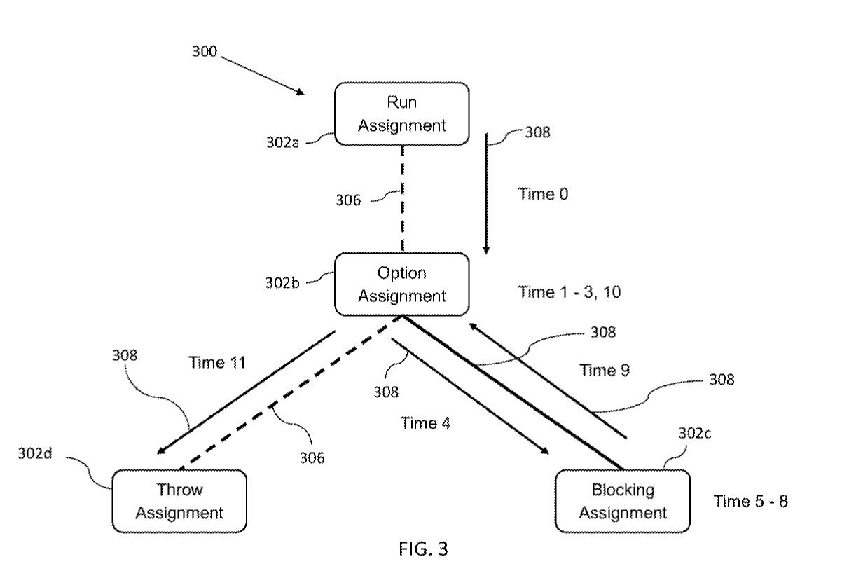

Referring now to FIG. 3, a traversal of another exemplary decision tree 300 is provided for a football scenario. The example in FIG. 3 is a non-linear tree traversal over time as a scenario is modeled. As with FIG. 2, the time steps during which each assignment 302a-302d (generally 302) is being carried out are indicated next to the assignments 302 and labeled “Time” with a numerical indicator of which time step is being represented. The flow path 308 shows the progression of the system through the assignments 302 of the decision tree 300, while the path 306 represents the terminal path for ending the scenario.

At the time step Time 0, the system instantly moves from the run assignment 302a to the option assignment 302b. From Time 1 to Time 3, the option assignment 302b is simulated within the model. During the time step 4 (Time 4), the scenario stimuli change, and the system follows the flow path 308 to move from option assignment 302b to blocking assignment 302c. The blocking assignment 302c is carried out for the time steps Time 5 through Time 8, before the stimuli change and the system returns, along flow path 308, to the option assignment 302b. The system stays on the option assignment 302b remains there to execute an additional action, such as a single step, before moving along the terminal path 306 to the final throw assignment 302d. In this way, the decision tree 300 is traversed for an exemplary football play scenario. While the terminal path 306 is linear, the actual path 308 that was taken is not linear.

The user may teach the system what should happen in a scenario by creating decision-trees for a given scenario for a set of entities. The information taught is known as scenario-specific information. When the system is asked to simulate (e.g. model) a scenario that it has no scenario-specific information for, it will rank the scenario-specific information it already knows by scenario similarity to the unknown scenario. In some cases, this information can be blended together to make new sets of decision-trees for the entities for the unknown scenario. This feedback blending technique greatly saves the user time when inputting scenario data, as the system's knowledge of the subject matter grows asymmetrically for each additional piece of information taught to it. These techniques, of populating decision trees for unknown, or otherwise incomplete scenarios, can be done by the system using PFMs, as discussed in more detail below.

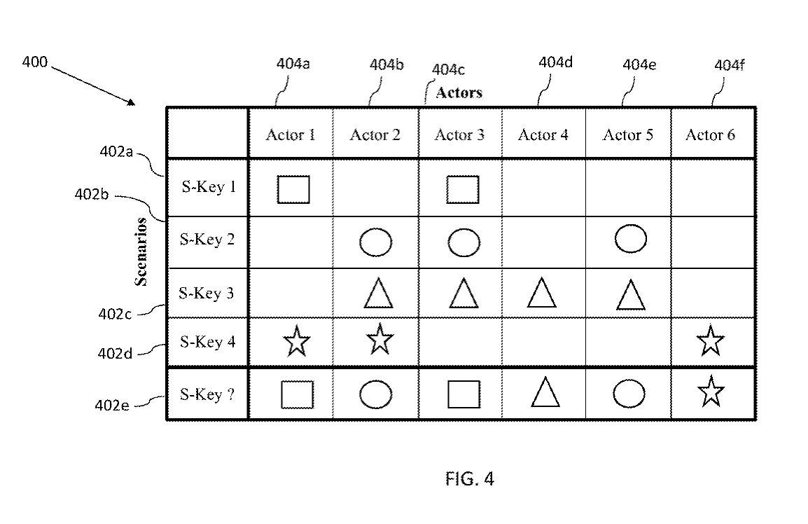

Referring now to FIG. 4, an exemplary PFM is shown generally at 400. PFM is a memory architecture leveraged by the system to enable it to effectively simulate scenarios the user has not taught it. When the system encounters a scenario that the user has not taught it, the system will rely on its knowledge of other similar situations to make an informed decision about the new scenario. The system does this by associating each scenario with a unique key known as a scenario-key. This key contains scenario-metadata for each scenario. Scenario keys are hashed using a hashing algorithm that seeks to find hash-collisions. Accordingly, similar keys produce closer hash values. When a user is populating the database with scenarios, whenever the user inputs a decision-tree for a particular actor in a scenario it is associated with a scenario key as part of the scenario-specific information stored on the system. Thus key-value pairing represents the standard hash-key to value map data structure. When the system is asked to simulate a scenario that it has not been taught, or may only have a partial understanding of, it leverages its feedback mechanism to create a polymorphic output derived from the scenario-specific information it has been taught in the past. It does this by first generating a scenario-key for the scenario in question. Then ranking the scenarios it has been taught using scenario-key hash similarities. Finally, it will take the list of ranked scenarios and work its way down the ranked list, filling-in each actor's decision-tree with the scenario-specific information held by the PFM at each iteration of the ranked list. This is known as the feedback portion, as the system is feeding back its own information into itself to produce an output. Thus the future unknown simulation-model output is a blended interpolation of past scenario-specific information. This blended interpolation of past information to future information is known as the polymorphic output. The form of the output depends not only on the individual scenario key and the scenario-specific information, but it also depends on its association to other similar scenarios. The user does not need to teach the system exactly how to model each scenario as it will create inferences between alike scenarios and produce a blended form of its past teachings. This technique increases the modularity of the components of the simulation which enables users to build the model faster as the system may reuse parts that have been inputted already. The PFM 400 is an example of how this is done.

On the left column of PFM 400, a plurality of scenarios 402a-402e (generally 402) are shown, while on the top row of the table of PFM 400, a plurality of actors 404a-404f (generally 404) are shown. The cell intersection of each scenario row 402 with an actor column 404 represents the decision tree for that actor in a given scenario. For the scenario 402a, those decision trees are represented by squares. Similarly, for the scenario 402b the decision trees are represented by circles, for the scenario 402c the decision trees are represented by triangles, and for the scenario 402d the decision trees are represented by stars. Notably, each actor's 404 decision tree across a given scenario 402 may be different, and the decision trees are only represented by shared symbols to denote which scenario 402 they are tied to. The scenario 402e is a new scenario the user has entered in the system and initially has no decision trees for any of the actors 404. At the time the PFM 400 is beginning to be populated, the scenario 402e is an incomplete scenario, with incomplete decision trees for all of the actors 404. This information is populated for the incomplete scenario 402e using the system's feedback capability to generate the PFM 400.

As metadata is entered for the incomplete scenario 402e, the system ranks other known scenarios 402 based on their degree of similarity to the incomplete scenario 402e by comparing the metadata. In some cases, the metadata includes hash values and the ranking is based on hash-collisions between the scenarios 402. In any case, the PFM 400 shows that the scenarios 402a-402d have been ranked by most to least similar to the scenario 402e based on their metadata. In particular, the scenario 402a was found to be most like the incomplete scenario 402e, while scenario 402d was the least like the incomplete scenario 402e. However, scenario 402d was still similar enough to scenario 402e that the system determined it was meaningful to use actor decision trees from scenario 402d to populate decision trees for scenario 402e. The PFM 400 then populates the decision trees for the actors 404 in scenario 402e based on the available decision trees from the highest ranked scenario 402. For example, scenario 402a is ranked the highest and has decision trees for two actors 404a, 404c that are in the incomplete scenario 402e. Therefore those decision trees are imported and used as the decision trees for those actors 404a, 404c in the incomplete scenario 402e. The PFM 400 then looks to the decision trees in the next highest ranked scenario 402b. The scenario 402b has decision trees for two additional actors 404b, 404e which are lacking a decision tree in the incomplete scenario 402e, and therefore their decision trees are imported into the new scenario 402e. Notably, while the scenario 402b also has a decision tree for the actor 404c, the PFM 400 does not rely on this decision tree for the actor 404c in the new scenario 402e since a decision tree has already been imported for actor 404c from the higher ranked scenario 402a. However, in some cases, the imported decision trees are blended from multiple known scenarios 402 based on ranking, as discussed in more detail below. The system then looks to the third ranked scenario 402c and the decision tree for actor 404d is imported. Finally, the system looks to the last ranked scenario 402d to import the decision tree from the one actor 404f who still does not have a decision tree. In this way, an exemplary PFM 400 is filled out and decision trees are populated automatically by the system for the new scenario 402e.

While the exemplary new scenario 402e described above used the PFM 400 to populate the decision tree for every actor 404, it should be noted that scenarios 402 with some decision trees can also be completed using a PFM to fill in the remaining decision trees. For example, the scenario 402a lacks information for the actors 404b, 404d-404f. This information could be filled in for the scenario 402a on the most similar ranked scenarios. To that end, actors 404b, 404e could have their decision tree populated for the scenario 402a by importing the decision trees of actors 404b, 404e from the closest ranked scenario 402b. Likewise, within scenario 402a, the decision tree for the actor 404d could be populated from the next ranked scenario 402c while the decision tree for the actor 404f could be populated from the final ranked scenario 402d.

In the event the hash-collisions and the associated scenarios are not 100% equal, the hashing formula is adjusted to increase the granularity of the scenario's hash value and all the scenario-key hash values in the given PFM are recalculated. Each PFM's scenario-keys are calculated with the same hashing formula but may contain different parameters used in the calculation to account for granularity differences between PFMs.

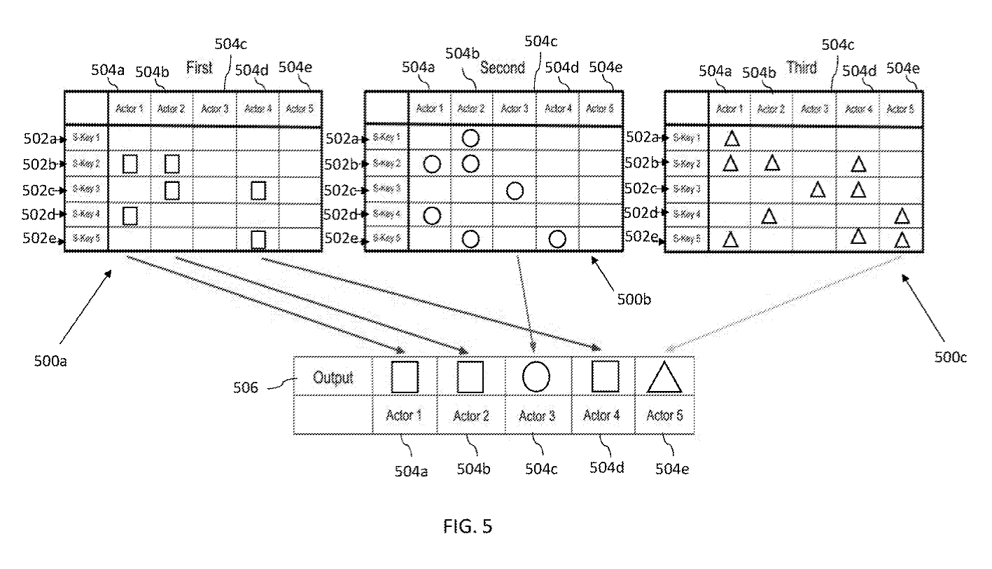

Referring now to FIG. 5, multiple PFMs 500a-500c (generally 500) may be used for a single scenario. When this occurs the system is able to blend information from the PFMs 500 into a single cohesive output to produce a more effective model. This process is described herein as PFM blending, and is similar to rank filtering described in FIG. 4 except that it occurs across PFMs. In PFM blending the ranking of the individual PFMs 500 is decided by the user. Ranking occurs in three possible ways: the sequential ordering of the PFMs 500 as they are specified in the scenario-metadata; the user categorizes each PFM 500 and the category they are associated with is assigned a rank; or the ranking occurs with a combination of the two previous strategies. In general, the PFMs 500 are ranked based on degree of PFM similarity to an incomplete scenario 506. In the example provided, the PFM 500a is ranked first, the PFM 500b is ranked second, and the PFM 500c is ranked third. Each PFM 500 includes scenario keys 502a-502e (generally 502) for five different scenarios and decision trees for at least some of the five actors 504a-504e in the incomplete scenario 506. As with FIG. 4, the presence of a decision tree for each actor 504 is represented by a symbol where the row for a scenario 502 intersects with the column for an actor 504. Squares represent decision trees from the highest ranked PFM 500a, while circles represented decision trees from the second ranked PFM 500b, and triangles represent decision trees from the last ranked PFM 500c. As some PFMs 500 may not contain information for all the actors 504, the blending of multiple PFMs 500 allows for the opportunity for all actors 502 to receive scenario metadata. When blending occurs, the output of higher order PFMs 500 takes precedence over lower order PFMs 500. Thus, actors 504 and decision trees are populated with information from higher order PFMs before lower order PFMs. This technique increases the modularity of the components of the simulation which enables users to build the model faster as the system may reuse parts that have been inputted already.

As shown, the PFMs 500 are blended to generate the decision trees for the five actors 504 in the incomplete scenario 506. The first PFM 500a is ranked highest and contains decision trees for actors 504a, 504b, and 504d. Thus, the decision trees for actors 504a, 504b, and 504d are imported into the incomplete scenario 506 based on the first PFM 500a. While both the second ranked PFM 500b and the third ranked PFM 500c contain decision trees for the actor 504b, those PFMs 500b, 500c are lower ranked than the PFM 500a, and therefore that information is not imported into the new scenario 506. Information for the actor 504c is imported from the highest ranked PFM 500 from which that information is available, which happens to be PFM 500b. Likewise, information for the actor 504e is imported from the lowest ranked PFM 500c, since PFM 500c is the only PFM 500 with information for the actor 504e.

Referring back to FIG. 1, it was described that usage of the system by instructors and testees could involve viewing the models, user-controlled testing, and data input. Model viewing gives the user the ability to view a stationary simulation model after creation, or a live motion simulation via output devices such as those described above. The user does this by specifying the scenario they would like the system to simulate by keyboard input or voice command. The system will generate the scenario and then display a modeled diagram of the simulation of the scenario at the first time step of Time 0. The diagrams of the actions and objects that the user sees in the model are computer generated 2-Dimensional (2D) or 3-Dimensional (3D) recreations of the items real-world form. The user then has the ability to press a play button to start the live-motion modeling of the scenario (made up of the “second models” generated at step 110 of flowchart 100). When this happens the system begins to traverse the actors' decision trees. From this traversal, an assignment vector is produced which the actors act on. Since a real world environment is being modeled, the user has the ability to move the camera during the simulation they are viewing. If the simulation is 3D they have the ability to change the camera angle as well. This enables the user to watch modeled scenarios and study their variabilities to gain an understanding of how they might play out in the real world. The user has the ability to pause, resume and restart the simulation at any time. Doing so causes the timing interval, or time step, process to halt, causing the underlying physics calculations of the model to stop until resumed.

When the system is operated as a user-controlled test, information is displayed in the same manner as during the modeling viewing process. The difference relates to how information is inputted into the system. Instead of a user viewing the model simulations passively, the user actively inputs data into the system that the system interprets as instructions for the user-controlled actor in the scenario. This is what is happening at step 108 of the flowchart 100, when the first model is generated using the input from the user-controlled actor or entity. The test begins with the user being instructed which scenario they are about to be tested in or the user selecting a simulation they are going to be tested in (i.e. scenario selection at step 106). Once a scenario is selected, the selected scenario name will appear on the screen of one of the aforementioned output sources or, or will be output by the system audibly. Sometimes the user is not instructed on which scenario they are about to be tested in and this step is skipped. When they have the option to select a scenario, they do so via keyboard input or voice command. The scenario model is then created and displayed at time-0 on the output source. The user then selects the actor they would like to control for the test. Next, the user performs some type of command to instruct the system to start the simulation. This command may be but is not limited to: pressing a button, holding down a button, voice prompt, or body gesture. Once the test begins every actor and object in the scenario will follow the actions of the system's live-motion model besides the user-controlled actor. Using an applicable aforementioned input device the user will transmit instructions to the system that the system will interpret as directives for the user-controlled actor in the simulation. It should be noted that during generation of the first model at step 108, the user's input actions with their chosen input device will be congruent to the actions and movements they would take in the real world. The user will continue to do this until the scenario terminates, at that point, the system will compare the user's actions to the ideal, or desired actions, and display an overall numeric grade to the user and/or a textual description of where they can improve (step 114). The user can then be prompted to begin another test in the same scenario or a different scenario and the process is repeated.

As discussed above, it is important to be able to input information in the scenario for various reasons, including populating the system with the requisite data and using the system during modeling. Information is inputted into the system in two manners, direct user-input, and passive user-input. Each user input process is done by directly interacting with the system through its standard input devices.

The first form of direct user input can be seen during step 104 when the user populates the system database with scenarios. At this step, the user builds and edits scenarios. It is the fastest way for a user to edit an existing scenario. This process takes place via a separate mechanism from the rest of the modeling and grading, if desired. For example, a separate computer or laptop device can be linked to the system for inputting scenario information. The user can enter a scenario type generally, informs the system of the general rules and physical characteristics to apply to the selected scenario. For example, a football scenario may include information about players, positions, field size, and entity movement characteristics, as just one example. The user is provided with a set of assignments that corresponds to the selected scenario. The user then selects the assignments and arranges them in decision trees associated with the actors in the scenario.

The user can also modify scenario-metadata. The user can set the number of actors in the scenario at the time the scenario is input. This is done by muting any of the actor's scenario specific-information output provided by the PFM. If an actor does not receive any specific-information they are automatically excluded from the scenario and the system models the scenario as if the muted actor never existed. As the user makes edits to the scenario-metadata, a new scenario key is generated with respect to the altered metadata. The new key is then associated with the subsequent modifications to the actors' decision-trees and assignments in the PFM. Thus every scenario-metadata change and/or corresponding decision-tree or assignment change results in a new key-value pairing in the PFM.

The second form of direct user input occurs when the user inputs the real-world scenarios grades of users into the system. It is understood this system is one of many forms that a user may use to prepare for a real-world scenario. For example, if a user controls an entity to generate a model at step 108, the system has the ability to allow a user (e.g. an instructor) to weigh in what the grade for that user generated model 108 should be based on how they controlled the selected entity during the scenario in additional to how the user reacted to the scenario in the real world. The instructor can weigh in in addition to the grade generated by the system, or can modify the grade provided by the system to make more accurate predictions on how well a user will perform in the live-motion simulated models.

For example, during the step 114, the system can use a combination of collaborative filtering and similarity searching to create models to predict the performance of a user in a scenario in the real world and in the simulated world. It does this by looking over all the user's live-motion simulated models tests and real-world practice reps (RWPR). For each test and RWPR, the system takes into account the time the user took the test or RWPR, the scenario used, the grade the user received in the simulated test or RWPR and the actor the user was when they took the simulated test or RWPR. The system then searches for similar scenarios (or uses averaging logic) to find scenarios that are similar to the scenario in question. When the scenario relevancy is being calculated, older tests or RWPRs are ranked lower and less tested scenarios are ranked higher. If the user has not taken enough tests or RWPRs for the system to perform the aforementioned calculation collaborative filtering is used. This can be done across data input into the system from multiple users, with the filtering predicated on other users that are similar to the user in question. User similarity is based on the user's role with respect to the system, their experience level, and their position (e.g. the entity's they control within a scenario). The search for similar scenarios, or averaging logic, is used on the most similar users with the system selecting scenarios based off of an aggregation of the other users' results. After this step, the system will have a collection of past scenarios practiced and their corresponding grades by the user or similar users in the real world or in the modeled tests. It will then take a weighted average of this collection of grades, this value is known as the Predicted Performance Metric (PPM). The weights in the PPM are based on the time the test or RWPR was taken and who took them. Older is weighted less and similar users are weighted more. If a user wanted to create a PPM for a given set of users in a given scenario, the user would specify the scenario and the users to be modeled and the corresponding PPMs would be calculated for each specified user resulting in a numerical model representing that set of users predicted performance for the given scenario.

The system also obtains passive user input as a user is being tested, which occurs as the user models a scenario and is graded. Passive input occurs when the user is being tested by the system. The system accumulates two types of data when the user is being tested by the system. Test performance data is collected during and after the user controls an entity to create a model of the scenario. This data includes but is not limited to, eye gaze analysis, decision making reaction time, the location of user actions, the current and final numeric grade for each assignment in the decision tree, the time the test took place, the overall numeric grade of the simulation and the scenario-metadata associated with the test. This data is aggregated and analyzed to provide specific feedback to the user on their areas of improvement. This information can also be used to create a virtual coach (e.g. where the system acts as a coach providing feedback) to help aid in subsequent modeling and grading of the user's performance. The second form of data collected by the system is the location and actions performed by the user over the time span of the scenario during generation of the first model at step 108. This information is aggregated for multiple users and categorized by scenario. The data is blended to create a single model of the accumulated movements and actions of the aggregated users' data. It is created by taking the weighted average of the aggregated assignment-vectors for each time step in the given scenario, this recreation is known as the user-weighted-average-model UWAM. This model can be used as a means of comparison to the user's actions, for example, as a second model relied upon in step 110.

To ensure the UWAM is generated accurately, the system takes steps to ensure only the actions of the most trusted users are being included in the model. Therefore the system can calculate a level of trust for each user based on their past overall grades. The UWAM can then be generated based only on the users with a level of trust that surpasses a user defined threshold, such as top 10%, for example. The rank is dependent on the user's overall numeric grade for tests in similar scenarios. The users overall numeric grade for tests in similar scenarios must meet a user-defined threshold as well. In this way, users with a higher grade attain a higher weight attributed to their assignment-vector location (or other actions) than users with a lower grade. At step 114, a particular user's actions can then be graded based on a comparison of the model generated from their actions at step 108 and one or more model actions from a UWAM generated at step 110.

At the user's discretion, the system can also re-train itself by re-adjusting the parameters of the associated assignments so the system's simulated model matches or trends toward the UWAM. The degree to which the assignment parameters are changed to match the UWAM is decided by the user. If the user decides to perform a system retraining, the assignments used and their corresponding decision-trees are linked to the exact scenario key used in the test. Then the new scenario-specific data created from the retraining is inputted into the PFM.

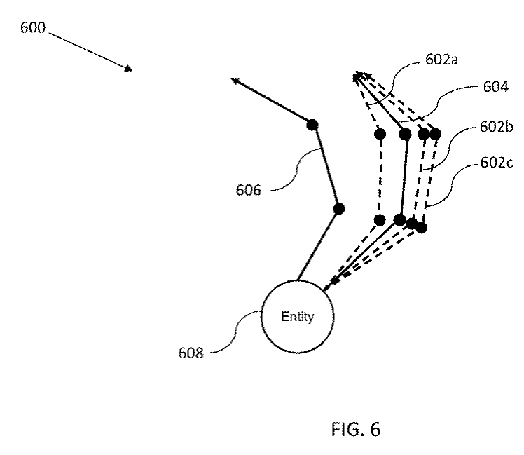

Referring now to FIG. 6, an example of system retraining based on a generated UWAM path is provided. FIG. 6 represents possible paths an entity 608 can take during a particular time step of a scenario. The paths 602a-602c represent the paths taken by three separate trusted users when controlling the entity 608 during modeling of the scenario in question. The path 606 represents the path of that entity 608 in the system's model of that same scenario, reflecting the system calculated desired action for the entity 608 during the same time step. As can be seen, the paths 602 of the trusted users all deviated from the system's path 606 by being offset somewhat to the right (as shown in FIG. 6). Therefore the system can make an adjustment to its own modeled path 606 by averaging the paths 602 of the trusted user. By doing this, the system generates path 604, which represents the path of the entity 608 in the UWAM. This process can be repeated as desired when a user desires to change the assignments, or expected correct assignments, of entities within a scenario based on a UWAM.

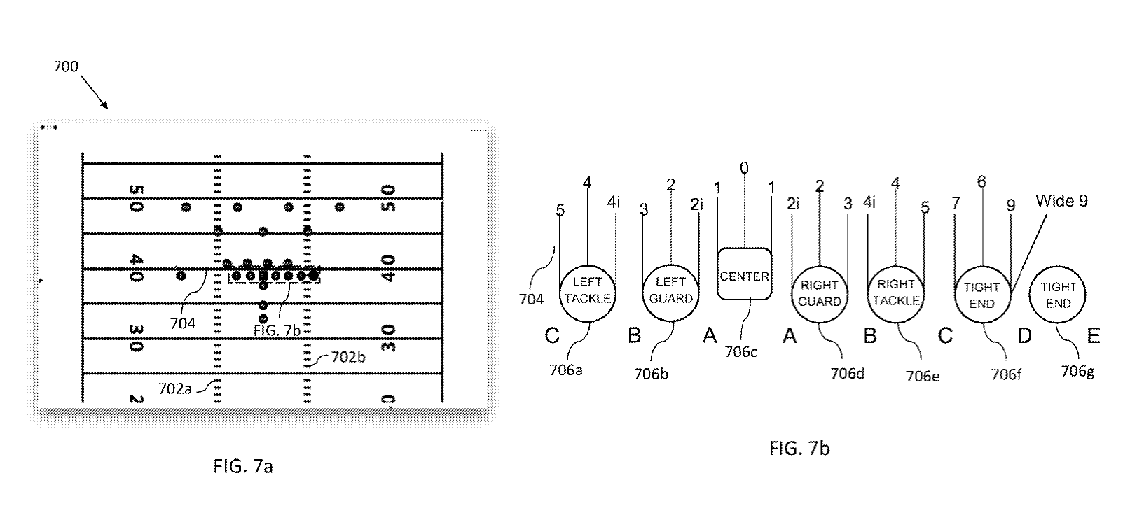

Referring now to FIG. 7a, an exemplary model of a scenario 700 in accordance with the subject technology is provided generally at 700. This scenario 700 takes place on a football field that is 300 feet, long by 160 feet, wide. The football field will be marked off with the standard major yard delineation lines every 10 yards with hash lines every 1 yard apart. There are two hash line columns 702a, 702b that will follow standard college football rule such that they are separated horizontally by 40 feet. The actual rules of the game will follow NCAA Collegiate tackle football rules and will not be discussed further for the sake of brevity. The actors in this scenario include 22 total actors, represented in the model by circles, with 11 actors on each team separated by the line of scrimmage 704. Since the actors in this scenario are humans, the rules governing their movement will follow standard earth-based physical limitations. FIG. 7b shows a zoomed in version of several of the actors 706a-706g (generally 706) from the model 700 who are on the offense and lined up along the line of scrimmage 704. This model further graphically identifies some of the assignments and/or laws governing those actors 706 formation and location within the scenario, particularly with references using typical football nomenclature. For example, the spaces between the actors 706 are identified as “gaps” using letter nomenclature, starting with the A gaps between the center 706c and left and right guards 706b, 706d respectively. Each additional gap is represented by a consecutive letter of the alphabet. The directional-side of the gap and/or alignment is denoted by applying the prefix right or left to the name of the gap or alignment. For example, the A gap to the left of the center is the left A gap. The numbers depicted above each actor 706 represent defensive technique alignments for those actors 706. In this way, the system recognizes and uses specific nomenclature for the scenario shown in model 700 since it is related to football. Other football scenarios will use similar football nomenclature, while other scenarios such as driving, flying a drone, or carrying out a military exercise, also have different specific nomenclatures used for scenarios of those types. This nomenclature is then used in automatic text descriptions of the assignment and PFMs. The player physical characteristics are set to be the average characteristics of a corresponding player in the same position in the real world. Often the system comes partially tailored for the general usage for a specific context. Meaning that the user will not have to set many of these general rules at the beginning of creating every scenario. In this context coaches (or other types of instructors using the system) will usually not have to set the field dimensions as that is the same for each every level of the sport nor will they have to set the physics laws.

While the stationary model 700 may be useful for a number of reasons, such as teaching a player formations, it should also be understood that during the course of modeling a scenario over a time period, the model 700 moves in real time to reflect the entities expected actions during the scenario. In this way, live-motion modeling diagrams are created and the user is able to control an entity in real time. It should also be understood that the model 700 is a two dimensional model, presented for the sake of simplicity. However, the system is also capable of presenting three dimensional models to better illustrate a real life scenario.

The model 700, and other models, are created using the building blocks described above, including scenarios with entities each having a decision tree (and any modifications to decision trees based on the user controlled actions), outside stimuli, and physical characteristics and general laws. The system achieves this by: updating the actor's understanding of the change scenario stimuli, constantly recalculating the decision tree's output and then having the actor perform the assignment-actions. This process is repeated every 10-120 ms for the length of a scenario as the modeling process is being carried out (e.g. steps 108 and 110 of flowchart 100). This process takes into account three factors, the actor's decision tree, scenario stimuli, and general laws. This process monitors scenario stimuli from the environment then uses that input in the tree iteration. To produce the assignment path for a given time step. The system then uses an assignment vector generated at the given time step (representing a desired action of an entity) to produce an assignment-action that corresponds to the assignment used. The physical movement and actions of the actors are limited by physical characteristics and general laws imposed on the actors during the creation of the scenario. If an actor is controlled by a user then the actor's movements and actions will be congruent to the user's input instead of being controlled by the system. Similar to stationary modeling the assignment-actions depictions are hardcoded into the system. Each action has a corresponding depiction that is either in a 2-dimensional or 3-dimensional form. The depictions are artistically designed to look and move as similar to the real-life example. Depictions of something that typically occurs in 3-Dimensions but displayed in 2-Dimensions on the system is illustrated to match industry standard diagramming methodologies and designs. The depictions reflect the models generated in the process described with respect to the flowchart 100, and can be presented to the user during or after the process of generating models pursuant to that process.

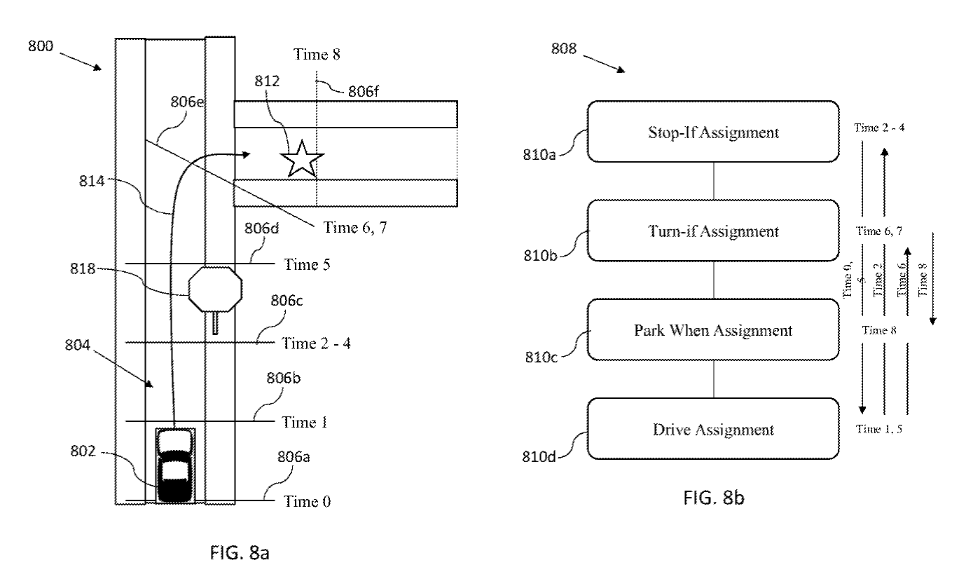

Referring now to FIG. 8a, another exemplary model 800 of a scenario being carried out in real time is shown. The scenario represented in model 800 is a vehicle 802 (acting as a variable object entity in the scenario) driving on a road 804. While only one frame of the model 800 is shown in FIG. 8, lines 806a-806e (generally 806) mark the location of the vehicle 802 at the various time steps (Time 0-Time 8) of the scenario. Referring now to FIG. 8b, as the time steps are carried out for the scenario, the decision tree 808 is traversed. In particular, the decision tree 808 includes a number of potential assignments 810a-810d (generally 810) which can be executed by the entity 802 over the course of the scenario, with the time steps each assignment 810 is executed during being shown to the right of the assignments 810.

As the model 800 carries out the scenario over time, the system has the ability to generate textual or audio feedback. The system can automatically generate a textual description of what the user is supposed to do in a scenario, create a textual description of the overall scenario, create a textual description of a specific actor's actions in a scenario, and/or tell the user what they did wrong at the end of a scenario test. The system is able to do this because each assignment's general logic is hard-coded into the system and is immutable. Thus the general logic of the assignments remains static. Accordingly, because the core structure of assignments of the same type is the same, a static textual description function is hard-coded for each assignment. The variables passed into the assignments by the user during the data input phase and the scenario stimuli are what enable the assignments to express themselves uniquely. These characteristics are what differentiate two assignments of the same type. Then the assignment's parameters are inserted into the textual description function so a unique textual description for a given assignment is generated. A description of what is supposed to occur in a scenario is generated using an amalgamation of the assignments textual description functions in a sequentially ordered fashion that matches the terminal path sequence of an actor's decision-tree. The system is able to tell the user what they did wrong and where they can improve at the end of a scenario test by first selecting the assignment that the user scored the lowest grade on in a scenario test then generating a the textual description of the lowest scored assignment. Before displaying the description to the user, the system appends a prefix statement or sentence to change the context of the description such that the message sounds as if their system is coaching the user or pointing out an area of weakness. All textual descriptions and messages discussed above may be converted into audio form through the use of simple text-to-speech technologies.

An example of a textual description of a model of a scenario is now discussed with respect to the model 800 of FIG. 8a. In the model 800, the vehicle 802 is being driven in accordance with the decision tree 808 until it reaches its final destination marking the end action of the scenario, which is denoted by star 812. The overall path of the vehicle 802 is depicted by arrow 814. As the scenario is carried out, the model 800 changes to reflect the car traveling along path 814 to reach the stop sign 818 and stopping at line 806c for time steps Time 2 through Time 4. The vehicle 802 then continues forward before making a right turn at line 806e (Time 6 and Time 7). Once the vehicle 802 reaches line 806f, at Time 8, the vehicle 802 has reached the scenario end event 812 which includes the assignment of parking the vehicle 802. Thus, the scenario ends and the model 800 of the scenario is complete when the vehicle 802 parks.

The decision tree 808 illustrates how the actions of the vehicle 802 are carried out over the time steps within the model 800. Assignment 810a indicates that the vehicle 802 is to stop if a particular even occurs, such as approaching the stop sign 818. Assignment 810b tells the car to turn if a particular even occurs, such as the vehicle 802 approaches the turn at line 806e. Assignment 810c tells the car to park if a particular event occurs, such as the parking location of 806f within the scenario is approached. The assignment 810d tells the vehicle 802 when it is supposed to keep driving during the scenario, at a user-determined speed and direction. These events are the assignment's parameters defined by the user. The parameters are what give the assignments their unique characteristics. Each assignment has a static textual function that may be populated with variables to make it human-readable to the extent that it properly describes the scenario. For example, the human-readable populated textual functions would produce the following output for each assignment (static portion being shown in regular text with the variable portion being shown in italics): Assignment 810a—Stop the car if 20 feet from a stop sign; Assignment 810b—Turn the car if there is a legal and safe right-hand turn; Assignment 810c-Park the car when you have arrived at the destination; Assignment 810d—Drive the car straight down the street at or below the speed limit.

The feedback, or grade provided by the user, can then likewise be provided via human-readable text. For example, in a case where the entity 802 is user controlled and failed a part of the scenario such as executing the turn assignment 810b, a textual description of what the user did wrong would be the description of the assignment appended with a prefix to change the context of the message to make it a coaching tip (e.g. feedback). An example of this would be (with the prefix underlined): Next time be sure to, turn the car if there is a legal and safe right-hand turn.” or “You failed to properly, turn the car if there is a legal and safe right-hand turn.” Thus, the descriptions of the various assignments can be relied upon to provide plain language feedback to a user indicating what the user did incorrectly and how the user could improve at each time step of a scenario.

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular implementation.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

What is claimed is:

1. A modeling system comprising:
a plurality of scenarios, each scenario containing at least one entity, each entity having a decision tree comprised of a plurality of possible actions associated with a plurality of time steps during said scenario;
a first model generated by carrying out a selected scenario of the plurality of scenarios, the first model displaying a position for each entity during the selected scenario, the first model configured to allow a user to control a selected entity of the at least one entities such that the user can indicate at least one suggested action for the selected entity during the scenario;
at least one second model generated by carrying out the selected scenario and adjusting the position of the entities in the selected scenario based on the at least one suggested action of the selected entity for each time step, the second models generating at least one desired action for the selected entity during each time step based on the decision tree and the at least one suggested action for the selected entity at a start of said time step; and
a display indicating a grade for the user based on a comparison of the user suggested action and the desired action at each time step.

2. The modeling system of claim 1, wherein the at least one desired action during a time step is adjusted based on suggested actions indicated by a plurality of users.

3. The modeling system of claim 2, wherein:
a level of trust is calculated for each of the plurality of users based on their grades; and
the degree to which the desired actions are adjusted based on the suggested actions indicated by one of the plurality of users is based on the level of trust for said user.

4. The modeling system of claim 1, wherein each scenario of the plurality of scenarios comprises scenario-metadata, the scenario-metadata including information related to scenario laws, entity physical characteristics, opposing entities, number of entities, scenario geographical location, time, scenario end events, and non-autonomous scenario objects.

5. The modeling system of claim 4, further comprising a simulation model of a new scenario input by the user, wherein scenario-metadata of the scenarios is compared to scenario-metadata of the new scenario to generate at least one decision tree for at least one entity in the new scenario.

6. The modeling system of claim 4, wherein:
each scenario comprises an associated scenario-key including the scenario-metadata; and
the scenario-keys include hash values.

7. The modeling system of claim 6, further comprising a simulation model of an incomplete scenario of the scenarios which includes at least one incomplete decision tree, the simulation model determining desired actions of the incomplete decision tree based on hash-collisions between a scenario-key of the incomplete scenario and at least one scenario-key of the others of the scenarios.

8. The modeling system of claim 6, further comprising a Polymorphic Feedback Map (PFM) comparing a hash value of an incomplete scenario to the hash values of other scenarios and ranking each other scenario based on a degree of similarity to the incomplete scenario, the PFM including a decision tree for each entity in the incomplete scenario based on one of the other scenarios based on the degree of similarity.

9. The modeling system of claim 6, further comprising a plurality of Polymorphic Feedback Maps (PFM) each comparing a hash value of an incomplete scenario to the hash values of other scenarios and ranking each other scenario based on a degree of similarity to the incomplete scenario, each PFM having a suggested decision tree for each entity in the incomplete scenario based on one of the other scenarios based on the degree of similarity,
wherein:
each PFM includes a degree of PFM similarity to the incomplete scenario; and
a decision tree for each entity in the incomplete scenario is based on a blend of the suggested decision trees of the PFMs based on the degree of PFM similarity to the incomplete scenario.

10. The modeling system of claim 1, wherein at least one of the desired actions include: a movement; and an event.

11. The modeling system of claim 1, further comprising:
at least one suggested assignment vector modeling a path suggested by the user based on the at least one suggested actions; and
at least one desired assignment vector modeling a path for the selected entity during each time step based on the at least one desired actions,
wherein the grade is further based on a comparison of the at least one suggested assignment vector and the at least one desired assignment vector at at least one shared time step.

12. The modeling system of claim 1, wherein the display includes feedback for the user, based on a comparison of the user suggested action and the desired action at each time step, indicating what the user did incorrectly and how the user could improve.

13. A method of modeling comprising:
populating a database with a plurality of scenarios, each scenario containing at least one entity, each entity having a decision tree comprised of a plurality of possible actions associated with a plurality of time steps during said scenario;
selecting a scenario of the plurality of scenarios;
generating a first model by carrying out the selected scenario, the first model displaying a position for each entity during the selected scenario;
controlling, by the user, a selected entity of the at least one entities to indicate at least one suggested action for the selected entity during the scenario;
generating at least one second model by carrying out the selected scenario and adjusting the position of the entities in the selected scenario based on the at least one suggested action of the selected entity for each time step, the second models generating at least one desired action for the selected entity during each time step based on the decision tree and the at least one suggested action for the selected entity at a start of said time step; and
indicating a grade for the user based on a comparison of the user suggested action and the desired action at each time step.

14. The method of claim 13, further comprising adjusting the at least one desired action during a time step based on suggested actions indicated by a plurality of users.

15. The method of claim 14, further comprising calculating a level of trust for each of the plurality of users based on their grades,
wherein the degree to which the at least one desired action is adjusted based on the suggested actions indicated by one of the plurality of users is based on the level of trust for said user.

16. The method of claim 13, wherein each scenario of the plurality of scenarios comprises scenario-metadata, the scenario-metadata including information related to scenario laws, entity physical characteristics, opposing entities, number of entities, scenario geographical location, time, scenario end events, and non-autonomous scenario objects.

17. The method of claim 16, further comprising generating a simulation model of a new scenario input by the user by comparing scenario-metadata of the scenarios to scenario-metadata of the new scenario to generate at least one decision tree for at least one entity in the new scenario.

18. The method of claim 16, wherein:
each scenario comprises an associated scenario-key including the scenario-metadata; and
the scenario-keys include hash values.

19. The method of claim 18, further comprising generating a simulation model of an incomplete scenario of the scenarios which includes at least one incomplete decision tree, the simulation model determining desired actions of the incomplete decision tree based on hash-collisions between a scenario-key of the incomplete scenario and at least one scenario-key of the others of the scenarios.

20. The method of claim 18, further comprising generating a Polymorphic Feedback Map (PFM) comparing a hash value of an incomplete scenario to the hash values of other scenarios and ranking each other scenario based on a degree of similarity to the incomplete scenario, the PFM including a decision tree for each entity in the incomplete scenario based on one of the other scenarios based on the degree of similarity.

21. The method of claim 18, further comprising generating a plurality of Polymorphic Feedback Maps (PFM) each comparing a hash value of an incomplete scenario to the hash values of other scenarios and ranking each other scenario based on a degree of similarity to the incomplete scenario, each PFM having a suggested decision tree for each entity in the incomplete scenario based on one of the other scenarios based on the degree of similarity,
wherein:
each PFM includes a degree of PFM similarity to the incomplete scenario; and
a decision tree for each entity in the incomplete scenario is based on a blend of the suggested decision trees of the PFMs based on the degree of PFM similarity to the incomplete scenario.

22. The method of claim 13, wherein the desired actions include: a movement; and
an event.

23. The method of claim 13, further comprising:
creating at least one suggested assignment vector modeling a path suggested by the user based on the at least one suggested actions; and
creating at least one desired assignment vector modeling a path for the selected entity during each time step based on the at least one desired actions,
wherein the grade is further based on a comparison of the at least one suggested assignment vector and the at least one desired assignment vector at at least one shared time step.

24. The method of claim 13, further comprising displaying feedback to the user indicating what the user did incorrectly and how the user could improve.
